(19) United States
(12) Patent Application Publication
(10) Pub. No.: US 2024/0426751 A1
(43) Pub. Date: Dec. 26, 2024

(54) WHITE LIGHT INTERFEROMETRIC INSPECTION USING TILTED REFERENCE BEAM AND SPATIAL FILTERING

(71) Applicant: Orbotech Ltd., Yavne (IL)

(72) Inventors: Nir A. Turko, Rehovot (IL); Hanina Golan, Rishon LeZion (IL); Igor Sakaev, Yavne (IL)

(21) Appl. No.: 18/212,036

(22) Filed: Jun. 20, 2023

(51) Int. Cl. G01N 21/45

(52) U.S. Cl. CPC G01N 21/45; G01N 2201/021

(57) ABSTRACT

Systems and methods for characterizing a sample utilizing white light interferometry are disclosed. Such systems and methods may include an optical sub-system. The optical sub-system may include a reference element configured to tilt an optical axis of a reference beam relative to an optical axis of a measurement beam and a sample positioning stage configured to adjust a sample position of a sample along a Z-direction of the sample. Such systems and methods may include receiving an image of the sample. Such systems and methods may include utilizing a filter to demodulate an interference pattern of the image. Such systems and methods may include determining a location of the interference pattern on the image; and directing the focal adjustment based on the location of the interference pattern.

### TECHNICAL FIELD

The present disclosure relates generally to white light interferometry and, more particularly, to white light interferometry using a tilted reference beam relative to the measurement beam.

### BACKGROUND

Inspection systems are used to inspect samples such as printed circuit boards (PCBs), wafers, and the like. The samples may be inspected to generate data such as three-dimensional (3D) data, surface height topologies, and/or images of the sample to be used for a variety of purposes. For example, a sample height or distance from the imaging system may be determined to focus properly on the sample or to unwrap an ambiguous phase map of the sample. There are various conventional methods for generating such data.

Conventional methods suffer from limitations such as, but not limited to, low throughput, the presence of speckle, occlusions, and/or fixed sensitivity.

Conventional white light interferometry (WLI) methods use a broad spectral band of white light to scan the z-axis for nanometric precision 3D measurements. The interferometer is often located inside the objective in a Mirau or Michelson arrangement, where a small portion of the light is back-reflected from a reference mirror surface. Features of the sample within the focal plane of the objective lens reflect or diffuse light which interferes upon the sensor with the light reflected from the reference mirror. As the features are scanned in the z-direction, different regions of the sample go in and out of focus, often correspondent to a coherence plane, and produce interference with the reference. The sensitivity is thus closely related to the coherence of the illumination source. In general, white-light sources emit light comprising a broad spectrum, resulting in lower coherence and finer z-resolution. A challenge with conventional WLI is that scanning the sample along the z-direction to obtain the focal position limits the throughput of the system.

In laser triangulation methods, a laser line illuminates the sample from an angle and is reflected to a sensor at the opposite angle. Due to the angle, reflection from different heights will illuminate the sensor on different coordinates. The difference between the measured and nominal coordinates is measured and the focus is dynamically corrected according to the calculated difference. However, laser triangulation may suffer from speckles caused by inherent high-coherence and low dynamic range relating to the monochromatic light, which will be susceptible to the sample spectral response.

Therefore, it would be advantageous to provide a system and method that overcomes the challenges described above.

### SUMMARY

A characterization system is disclosed in accordance with one or more illustrative embodiments of the present disclosure. In one illustrative embodiment, the system includes an optical sub-system and a controller. In another illustrative embodiment, the optical sub-system includes a detector, an illumination source, a beamsplitter, a reference element, and a sample positioning stage. In another illustrative embodiment, the controller is communicatively coupled to the detector and the sample positioning stage. In another illustrative embodiment, the controller includes one or more processors configured to receive an image of the sample, utilize a filter to demodulate an interference pattern of the image, determine a location of the interference pattern on the image, and directing a focal adjustment based on the location of the interference pattern.

A method is disclosed in accordance with one or more illustrative embodiments of the present disclosure. In one illustrative embodiment, the method includes providing an optical sub-system configured for characterizing a sample utilizing white light interferometry. In another illustrative embodiment, the optical sub-system includes a reference element configured to tilt an optical axis of a reference beam relative to an optical axis of a measurement beam and a sample positioning stage configured to adjust a sample position of a sample along a z-direction of the sample. In another illustrative embodiment, the method includes receiving an image of the sample, utilizing a filter to demodulate an interference pattern of the image, determining a location of the interference pattern on the image, and directing a focal adjustment based on the location of the interference pattern.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1A is a simplified block diagram view of a characterization system, in accordance with one or more embodiments of the present disclosure.

FIG. 1B is a simplified schematic view of an optical sub-system, in accordance with one or more embodiments of the present disclosure.

FIG. 2A is a conceptual view of a coherence region between a reference beam and a measurement beam at the sample, in accordance with one or more embodiments of the present disclosure.

FIG. 2B is a conceptual view of a coherence region between the reference beam and the measurement beam at the sample including a raised feature, in accordance with one or more embodiments of the present disclosure.

FIG. 2C is a conceptual view of a coherence region between the reference beam and the measurement beam at the sample including a semi-transparent layer, in accordance with one or more embodiments of the present disclosure.

FIG. 2D is a conceptual view of a coherence plane between the reference beam and the measurement beam to illustrate resolution and sensitivity, in accordance with one or more embodiments of the present disclosure.

FIG. 3A is an image of a step target including a calibrated focus location, in accordance with one or more embodiments of the present disclosure.

FIG. 3B is an amplitude image derived from the image of the step target in FIG. 3A, in accordance with one or more embodiments of the present disclosure.

FIG. 4 is a simplified schematic view of an optical sub-system including an external Mach-Zehnder interferometer configuration, in accordance with one or more embodiments of the present disclosure.

FIG. 5 is a simplified schematic view of an optical sub-system including an in-objective interferometer configuration, in accordance with one or more embodiments of the present disclosure.

FIG. 6 is a flow diagram illustrating steps performed in a method, in accordance with one or more embodiments of the present disclosure.

FIG. 7 is a flow diagram illustrating steps performed in a method, in accordance with one or more embodiments of the present disclosure.

FIG. 8 is a flow diagram illustrating steps performed in a method, in accordance with one or more embodiments of the present disclosure.

FIG. 9 is a flow diagram illustrating steps performed in a method utilizing a band pass filter, in accordance with one or more embodiments of the present disclosure.

FIG. 10 are simplified views of images of a bump feature during a lateral scan as may be utilized in a phase map unwrapping process, in accordance with one or more embodiments of the present disclosure.

FIG. 11A is a demodulated image of periodic features and interference patterns, in accordance with one or more embodiments of the present disclosure.

FIG. 11B is a filtered image of the same field of view as in FIG. 11A after applying a spatial filter with a narrower bandpass window to demodulate the interference patterns, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to using interference patterns to characterize a sample, wherein the interference patterns are generated using a tilted optical axis of a reference beam in a white light interferometry configuration and filtered utilizing a spatial filter to demodulate the interference patterns. For example, a height, surface height topology, vertical scan data, and/or the like may be generated using the interference patterns. For instance, a tilted reference beam causes the interference pattern to vary location along the x-axis as the sample moves in the z-axis. In this regard, the particular locations of the interference patterns in the images of the sample directly correspond to particular heights of the sample and/or particular distances between the sample to a characterization system. Therefore, determining the interference pattern location may allow for an operation such as, but not limited to, auto-focusing during a lateral scan of the sample by comparing the interference pattern location to a (known) calibrated location of focus of the characterization system.

In embodiments of the present disclosure, the optical axis of the reference beam is tilted at an angle relative to the optical axis of the measurement beam (i.e., the beams are non-parallel relative to each other) at the sample and/or near the sample. In this regard, a coherence region is created between the (tilted) reference beam and the measurement beam. The location of the coherence region of the measurement beam and the reference beam corresponds to the interference pattern at the detector. In embodiments, conceptually, the coherence region may be an area where a coherence plane of the (tilted) reference beam crosses a coherence plane of the measurement beam. For a flat sample, as the sample is moved in a z-direction (e.g., vertically), the coherence region varies laterally (i.e., in an x-direction and/or y-direction) as a function of a height (i.e., z-direction position) of the sample. The coherence region may correspond to an interference pattern on an image of the sample. In this regard, a height/distance of at least a portion of a sample may be determined using a single image.

Conventional methods for focusing a sample can present challenges. For example, focusing may require stopping the lateral movement of the sample to obtain multiple focusing images scanned along the z-direction (e.g., depth direction), in order to determine the best focus for the sample. Alternatively, tilting the interferometer may be used to focus the sample, as is disclosed in U.S. Pat. No. 6,449,048, issued on Sep. 10, 2002, which is incorporated herein by reference in the entirety. Tilting the entire interferometer may (in theory) reduce a need for scanning in the z-direction. However, the three-dimensional features of the sample viewed at an angle may lead to occlusions. Further, fringe projection techniques may use relatively large angles for increased sensitivity, which can cause large occlusions when tall features are present.

It is noted, however, in embodiments of the present disclosure, that tilting the reference beam, with the measurement beam being generally non-tilted for purposes of imaging, allows for occlusion-free lateral scanning. In this regard, a sample may be laterally scanned while simultaneously and continuously adjusting the focal distance of the sample, without needing to stop to focus using multiple images along the z-direction and without three-dimensional feature occlusions caused by viewing at a tilted angle. Note that focusing during a lateral scan is merely an example of an operation that embodiments of the present disclosure may provide for, and many other operations are provided for.

Embodiments may utilize a filter such as a spatial filter. Utilizing a spatial filter may more efficiently and/or effectively determine the location of the interference pattern.

For purposes of the present disclosure, the language of “location of the interference pattern”, and the like include determining a location such as, but not necessarily limited to, determining a center/peak of the interference pattern, mapping a fit function to the interference function, and/or the like.

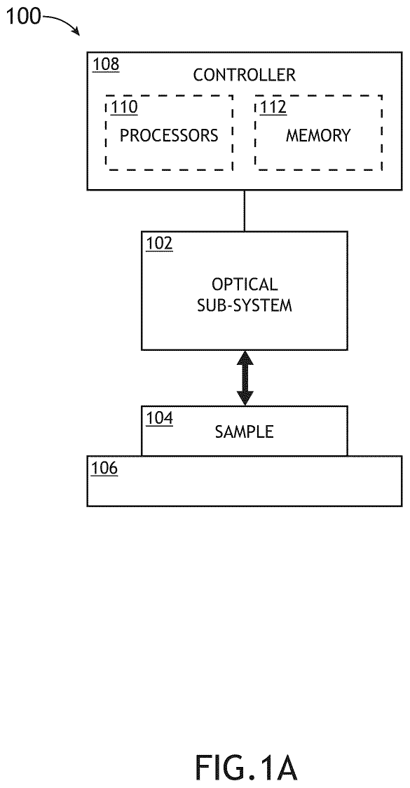

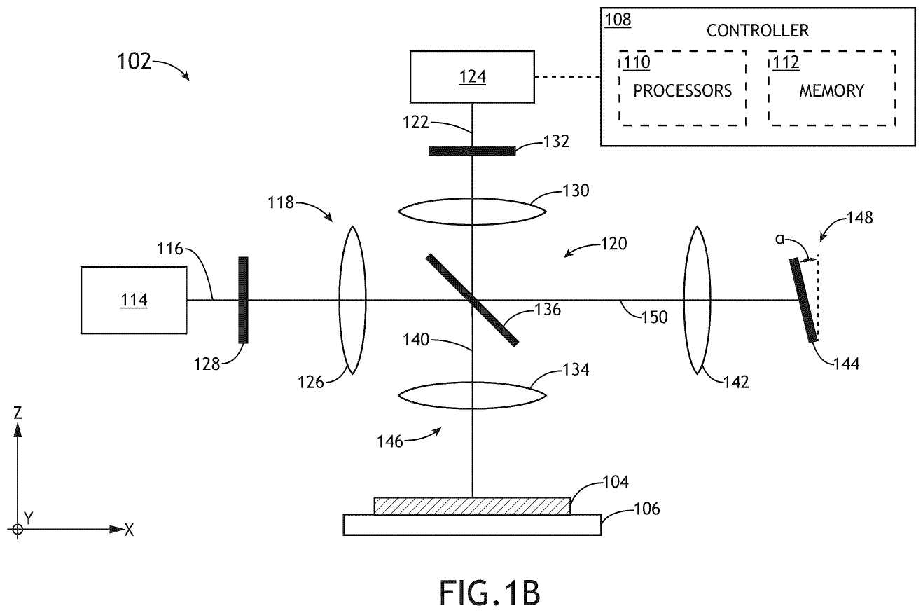

FIG. 1A illustrates a simplified block diagram view of a characterization system 100, in accordance with one or more embodiments of the present disclosure.

The characterization system 100 includes an optical sub-system 102 configured to acquire one or more images from a sample 104 and a controller 108 communicatively coupled to the optical sub-system 102.

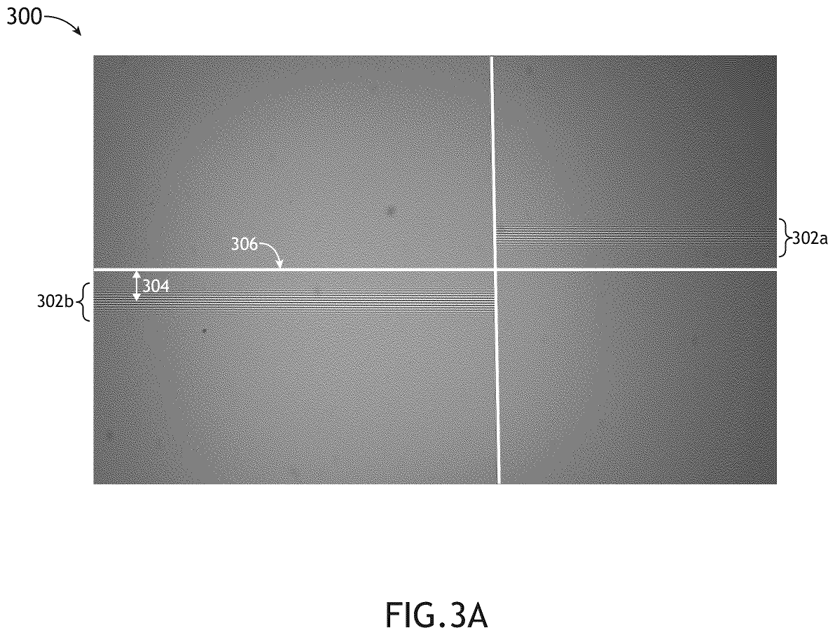

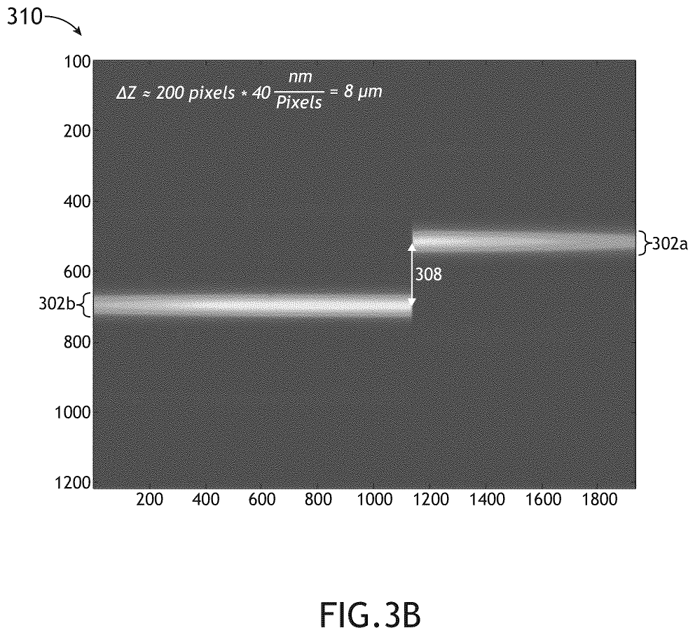

In this regard, the one or more processors 110 of the controller 108 may execute any of the various process steps described throughout the present disclosure. For example, the one or more processors 110 of the controller 108 may determine a location of an interference pattern on an image, and focus the optical sub-system based on the location of the interference pattern. For example, focusing (i.e., directing a focal adjustment) may include adjusting at least one of a sample positioning stage 106 to adjust the sample 104 position, a group of optical elements, or the entire optical sub-system 102. An example of an interference pattern 302 is shown in FIG. 3A. The group of optical elements may be, but not necessarily required to be or limited to, a lens such as an objective lens and/or the like, the beam splitter, and the reference element.

FIG. 1B illustrates a simplified schematic view of an optical sub-system 102, in accordance with one or more embodiments of the present disclosure.

In embodiments, FIG. 1B illustrates an example white light interferometer configuration of an optical sub-system 102 including a measurement arm 146 associated with a sample 104 and a reference arm 148 associated with a reference element 144.

In embodiments, the reference element 144 is any element known in the art for directing an optical axis of a beam. For example, the reference element may include, but is not limited to, a reflecting element (e.g., mirror, beamsplitter, and the like), or another modulating element (e.g., optical lens, optical grating and the like). For example, as shown in FIG. 1B, the reference element 144 may be a reflecting reference element (e.g., mirror) positioned at an angle (a) to cause a tilt of the optical axis of the reference beam 150 relative to the optical axis of the measurement beam 140.

In embodiments, the optical sub-system 102 includes an illumination source 114 configured to generate the illumination beam 116. In embodiments, the characterization system 100 includes an illumination pathway 118 including one or more components (e.g., illumination lenses 126) to direct the illumination beam 116 to the sample 104.

In embodiments, the optical sub-system 102 includes the collection pathway 120 including one or more components (e.g., collection lenses 130, a spatial filter 132, and/or the like) to collect light from the sample 104. It is noted that “illumination”, “light”, “beam”, “illumination beam”, and the like may be interchangeable as used throughout the present disclosure.

In embodiments, the optical sub-system 102 includes at least one detector 124 configured to capture at least a portion of detectable light 122 from a collection pathway 120. For example, the detector 124 may receive images with interference patterns thereon. As used herein, detectable light 122 includes portions of illumination that are directed to the detector 124 and includes illumination emanating from the sample 104.

In embodiments, the detector 124 is a multi-pixel detector (e.g., camera, 2D detector, and the like). For example, a detector 124 may include, but is not limited to, a photodiode array (PDA), a charge-coupled device (CCD), a complementary metal-oxide semiconductor (CMOS) device, a time-delay integration (TDI) detector, a line-scan detector, a photomultiplier tube (PMT), an avalanche photodiode (APD), or the like.

In embodiments, the optical sub-system 102 includes a sample positioning stage 106 configured to adjust a focal distance relative to the sample 104. For example, the focal distance may be adjusted by adjusting the sample position. For example, FIG. 1B illustrates a sample positioning stage 106 to adjust the position of the sample 104 along any dimension such as, but not limited to, a lateral position within the x-direction and/or y-direction, axially along the z-direction, tip, tilt, or the like. In embodiments, alternatively and/or additionally, the optical sub-system may be configured to adjust the focal distance by adjusting the measurement beam 140 and reference beam 150 via an optical element (e.g., objective lens 134, or the like).

For lateral scanning, although not shown, the optical subsystem 102 may include one or more scanning optical elements suitable for scanning the beams 140, 150 across the sample 104. However, note that a lateral scanning may also, and/or alternatively, be performed by moving the sample 104 with the sample positioning stage 106.

In embodiments, the optical sub-system 102 may be configured to perform a selective blocking of the reference beam 150 in order to receive secondary images without the interference pattern 302. For example, the optical sub-system 102 may include a shutter (not shown) or beam deflector (e.g., actuatable mirror, actuatable lens) to selectively block (e.g., absorb, deflect away, and the like) the reference beam 150 in the reference arm 148 from reaching the detector 124 during a measurement/imaging. In this regard, the interference patterns 302 caused by the reference beam 150 may be repeatedly removed/added for dual-use imaging. For example, when the interference patterns 302 are blocked, the secondary images may have improved clarity, and when added/unblocked, the interference patterns 302 of the images may be used for focusing purposes. For instance, the reference beam 150 may be configured to be un-blocked once every image/frame cycle and/or once every few images/frames to focus the sample 104 during a lateral scan. In such a configuration, the detector 124 used for capturing secondary images may be the same detector used for focusing (e.g., using images with the interference pattern 302), and vice versa. In embodiments, the selective blocking of the reference beam 150 may be considered a “fast switching.” Such a selective blocking may enable even faster operations, such as relatively faster auto-focusing and lateral scanning.

In embodiments, directing a focal adjustment (i.e., focusing) of the sample 104 may be performed continuously, such as during a lateral scan.

In embodiments, the optical sub-system 102 includes a beamsplitter 136 configured to split the illumination beam 116 into a measurement beam 140 and a reference beam 150.

In embodiments, the optical sub-system 102 includes a reference objective lens 142 configured to receive and direct the reference beam 150 to the reference element 144, and receive light reflected from this reference element 144. In this regard, the reference objective lens 142 (although not necessarily required) and the reference element 144 may define a reference arm 148 of the optical sub-system 102. Similarly, the measurement beam 140 and objective lens 134 (e.g., which may include a measurement objective lens) may define the measurement arm 146. As shown, the measurement arm 146 and the reference arm 148 at least partially overlap.

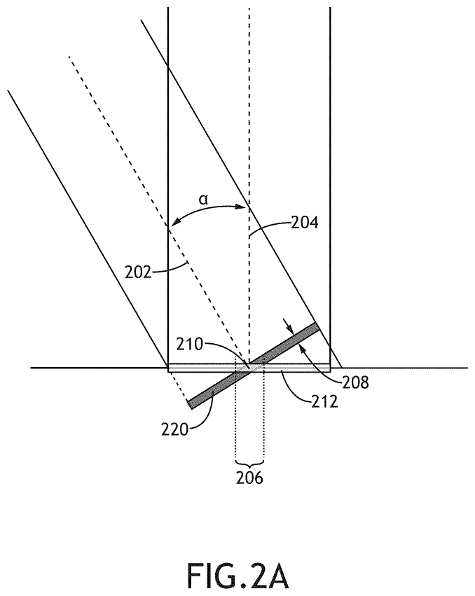

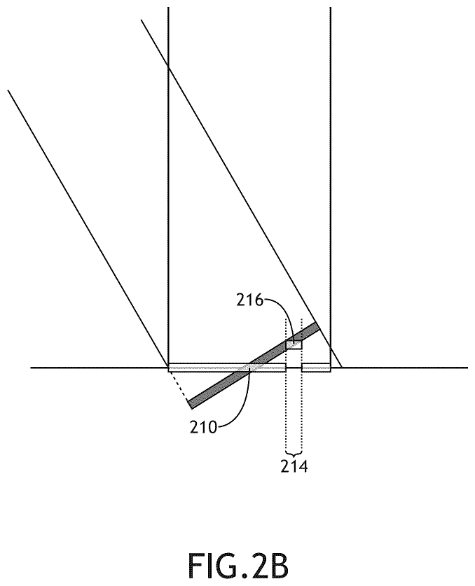

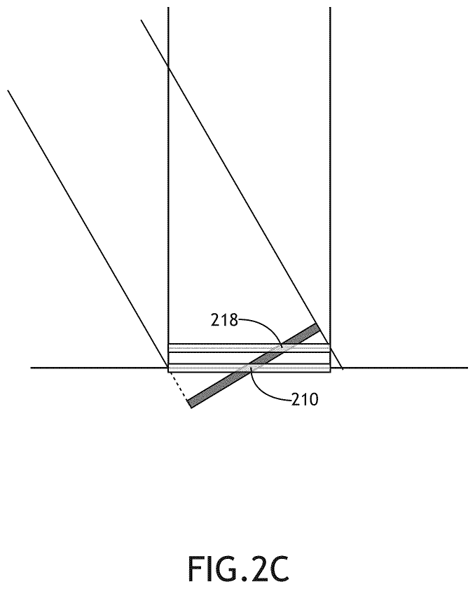

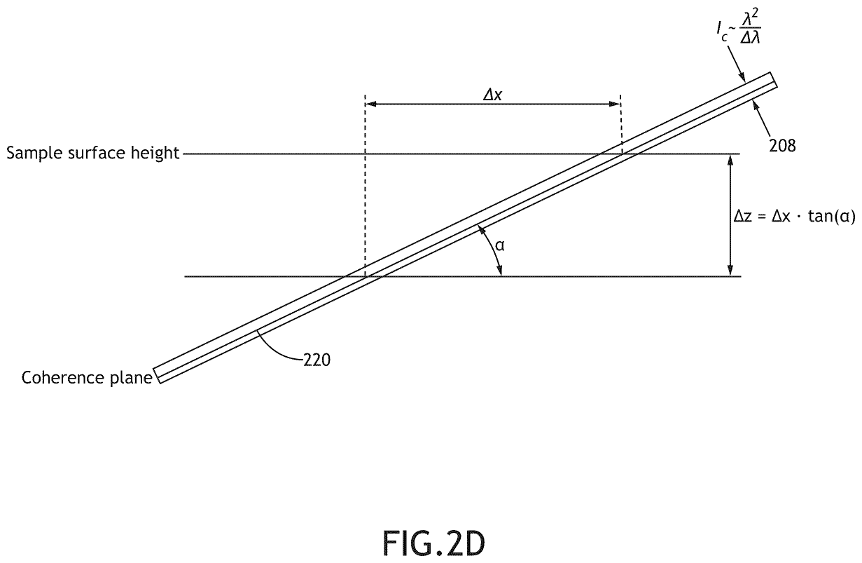

FIGS. 2A through 2C are a series of conceptual views depicting scanning coherence gating, in accordance with one or more embodiments of the present disclosure.

Note that for purposes of the present disclosure, determining a “height” of the sample 104 may also refer to determining a distance between the sample 104 and the optical sub-system 102.

FIG. 2A illustrates a conceptual view of a coherence region 210 determined by the mutually coherent planes 212, 220 of a reference beam 202 and a measurement beam 204 at the sample 104, in accordance with one or more embodiments of the present disclosure.

An effective interference region on a sensor (L) 206 is a function of a coherence length (l_{c}) 208. The coherence length (l_{c}) 206 is a function of the wavelength (λ) and spectral width (Δλ).

The coherence length (l_{c}) 208 is provided by Eq. 1:

$${l}_{c} = ( \frac{{λ}^{2}}{Δλ} \frac{2 ln 2}{π} ) \qquad ( Eq . 1 )$$

The effective interference region on the sensor (L) 206 is provided by Eq. 2:

$$L = \frac{{l}_{c}}{sin ( α )} \qquad ( Eq . 2 )$$

For low coherence light, the coherence length (l_{c}) 208 is relatively short, resulting in a relatively narrow effective interference region on the sensor (L) 206.

For a flat sample 104, the effective interference region on the sensor (L) 206 corresponding to an interference pattern on the sensor moves along the x-axis as a function of the sample 104 moving in the z-axis.

FIG. 2B illustrates a conceptual view of a coherence region 210 and a second coherence region 216 between the reference beam 202 and the measurement beam 204 at the sample 104 including a raised feature, in accordance with one or more embodiments of the present disclosure.

In embodiments, a raised feature (e.g., bump) 214 of a sample 104 may cause a second effective coherence region on a sensor (L) 214 The raised feature results in a second coherence region 216 higher in the z-direction. Other coherence regions of interference may exist according to various height differences of the sample 104.

FIG. 2C illustrates a conceptual view of a coherence region 218 between the reference beam 202 and the measurement beam 204 at the sample 104 including a semi-transparent layer, in accordance with one or more embodiments of the present disclosure.

For example, one or more semi-transparent layers (e.g., deposited substrate layers, or any other layer or coating) may cause a coherence region 218 with a corresponding interference pattern on an image. These coherence regions 218 may depend on a layer thickness. Note that for purposes of the present disclosure, semi-transparent layers include layers that are at least partially transparent, as well as layers that are fully transparent or nearly fully transparent.

In this regard, one or more layers may be identified using the various corresponding interference patterns 302 produced from such coherence regions (e.g., coherence region 218).

FIG. 2D illustrates a conceptual view of coherence plane 220 to illustrate resolution and sensitivity, in accordance with one or more embodiments of the present disclosure.

The resolution may be characterized by Eq. 1 and Eq. 2 above for determining the effective interference region on a sensor (L) 206 and the coherence length (l_{c}) 208.

The sensitivity is determined based on the tilt angle (a) of the reference beam 202:

$$Δ z = Δ x tan ( α ) \qquad ( Eq . 3 )$$

Consider an example scenario where each pixel is 1.15 microns and a is 2 degrees.

In such a scenario:

$$\frac{Δ z}{Δ x} ≅ 40 [ \frac{nm}{pixel} ] \qquad ( Eq . 4 )$$

In this way, a change in height (Δz) of 10 microns causes a measurable shift (Δx) of the interference pattern of 250 pixels in the received image. Moreover, the calculations may be reversed to determine the change in height (Δz) of the sample 104 based on the measurable shift Δx. An example of the measurable shift Δx is shown by measurable shift Δx 308 between interference pattern 302a and interference pattern 302b of FIG. 3B.

FIG. 3A illustrates an image 300 of a step target including a calibrated focus location 306, in accordance with one or more embodiments of the present disclosure. Note that the image 300 of the step target includes two interference patterns 302, each interference pattern 302 corresponding to a different region of the sample 104 having a unique height.

The step target shows an 8 micron change in height step corresponding to a roughly 200-pixel difference in locations of interferences patterns 302a, 302b in the image 300 as originally received. This difference results in a roughly 0.04 micron per pixel correlation between sample height and pixel location of the interference patterns 302a, 302b.

In embodiments, the sample height may be actuated dynamically to a calibrated focal plane (i.e., focus location) of the optical sub-system 102 by calibrating the focal position. For example, multiple images along the z-axis may be obtained for a reference sample (e.g., flat sample) until the sample is in focus. Further, the location on the detector 124 (e.g., sensor) of the interference pattern 302 at that focal distance may correspond to a calibrated focus location 306.

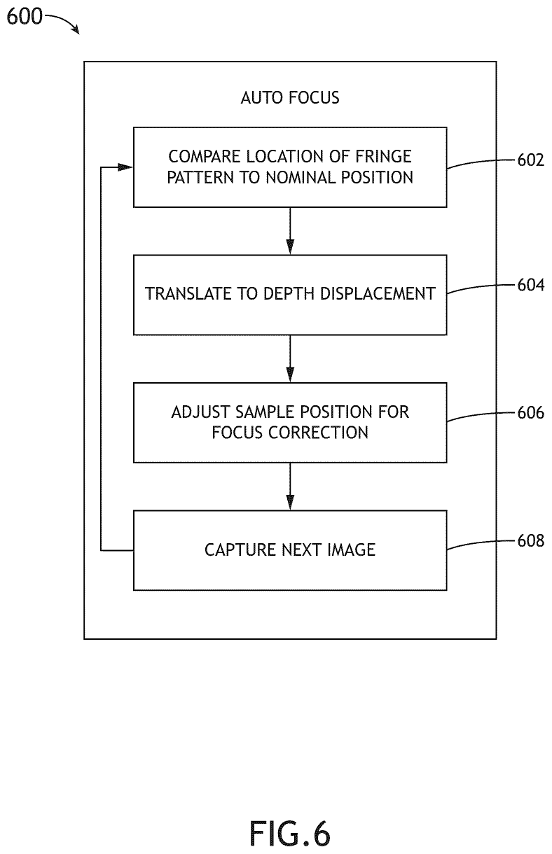

For example, a method of focusing is shown in FIG. 6. Such a method may include various steps, such as receiving a calibrated focus location 306; and determining a difference 304 between the calibrated focus location 306 and the location of the interference pattern 302 on an image. For example, the difference may be, include, correspond, or be derived from the Δx previously described.

FIG. 3B illustrates an amplitude image 310 derived from the image 300 of the interference pattern 302 of the step target in FIG. 3A, in accordance with one or more embodiments of the present disclosure. For example, image 310 may be a filtered or processed image of image 300 configured to allow for tracking the interferences patterns 302a, 302b.

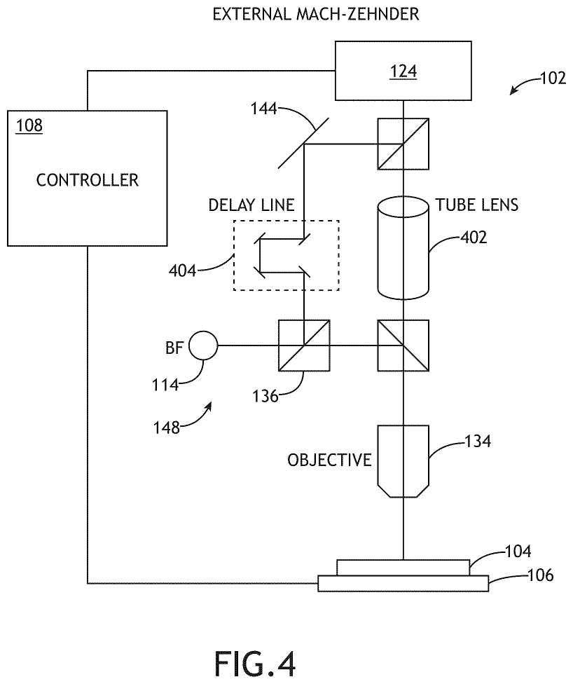

FIG. 4 illustrates a simplified schematic view of an optical sub-system 102 including an external Mach-Zehnder interferometer configuration, in accordance with one or more embodiments of the present disclosure.

In embodiments, the optical sub-system 102 in an external Mach-Zehnder interferometer configuration includes a delay line 404. The delay line may include one or more (e.g., four) reflecting surfaces (e.g., mirrors, beamsplitters, and the like). Although the reference element 144 is shown as directing a roughly perpendicular reference beam for simplicity of illustration, the reference element 144, in embodiments, directs the reference beam such that it is tilted (e.g., at the angle α) relative to the measurement beam at the sample.

In embodiments, the optical sub-system 102 in an external Mach-Zehnder interferometer configuration includes additional beamsplitters 136 and/or a tube lens 402. The tube lens 402 may collimate the reference beam.

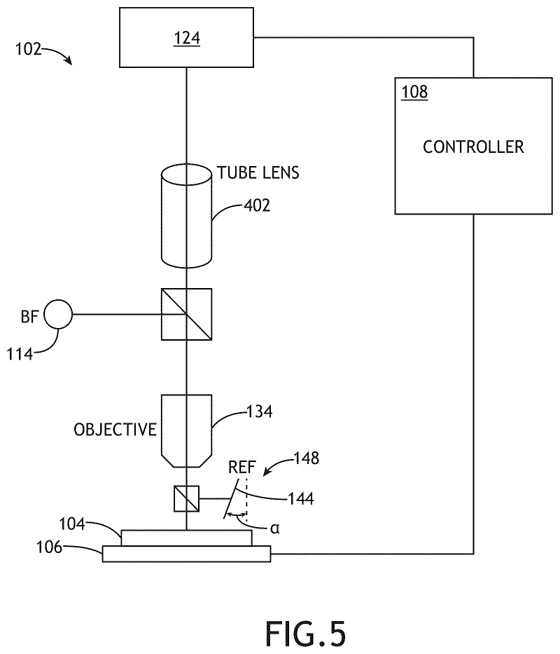

FIG. 5 illustrates a simplified schematic view of an optical sub-system 102 including an in-objective interferometer configuration, in accordance with one or more embodiments of the present disclosure.

In embodiments, the optical sub-system 102 is an in-objective interferometer configuration includes a reference element that tilts the reference beam at, near, and/or after the objective lens 134.

In embodiments, the optical sub-system 102 is an in-objective interferometer configuration includes a tube lens 402.

In embodiments, the optical sub-system 102 is an in-objective interferometer configuration includes a beamsplitter located after an objective lens 134 along a direction of propagation of the illumination beam 116.

FIG. 6 illustrates a flow diagram illustrating steps performed in a method 600, in accordance with one or more embodiments of the present disclosure.

In a step 602, a location of an interference pattern 302 (e.g., fringe pattern) is compared to a nominal position of known height (e.g., calibrated focus location 306).

In a step 604, the location of the interference pattern 302 is translated to a height based on the comparison to the nominal position in step 602.

In a step 606, a focal adjustment is directed by adjusting at least one of a sample position or an optical element. The focal adjustment is based on the translation of the interference pattern 302 in step 604. For example, the sample positioning stage 106 may be used to adjust the sample position in the z-direction based on the location of the interference pattern 302. For instance, the sample position may be adjusted during a lateral scanning of the sample 104 to maintain focus (e.g., auto-focus). By way of another example, an optical element such as the objective lens may be adjusted (e.g., moved, warped, and the like) such that the focal distance of the optical sub-system 102 is moved along the z-direction.

In a step 608, a next image is captured. For example, another image of the sample 104 may be received and above steps repeated.

In embodiments, a focusing may include determining a max height difference from the calibrated focus location which can be measured (determined by the sensor pixels number and the reference beam tilt angle), and limiting the movement of the z-stage not to exceed the measurement range.

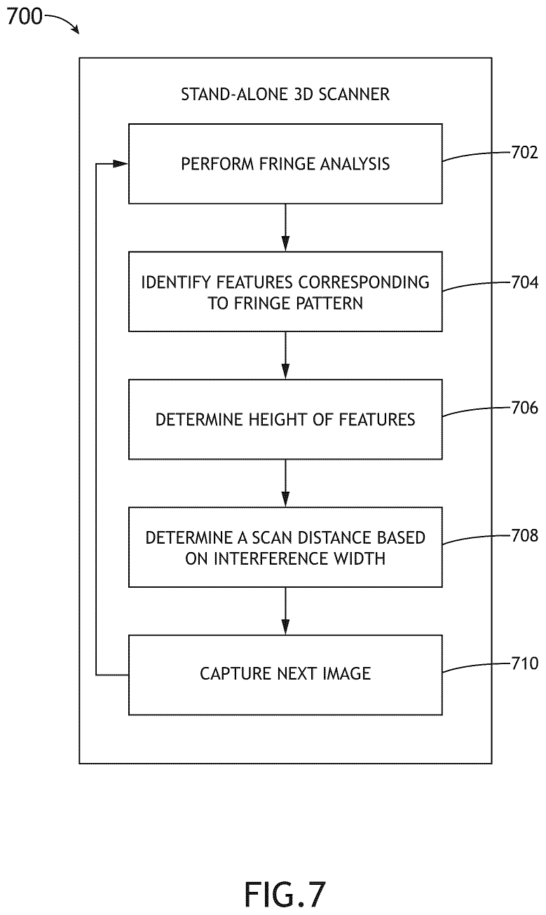

FIG. 7 illustrates a flow diagram illustrating steps performed in a method 700, in accordance with one or more embodiments of the present disclosure.

In a step 702, fringe analysis is performed on the sample 104. For example, the optical sub-system 102 may be configured to characterize the sample 104 utilizing white light interferometry to generate data (e.g., surface height topology) of the sample 104 based on interference patterns 302 (e.g., including “fringe” patterns to be analyzed) received during a lateral scan.

In a step 704, features corresponding to the interference patterns 302 are identified. For example, features may include, but are not limited to, changes in surface height of the sample such as bumps, defects, steps, solderable components, other electrical components, and/or any other features.

In a step 706, a height of the features is determined.

In a step 708, a scan distance is determined based on an interference width. For example, a feature may be scanned along the z-axis, y-axis, and/or x-axis.

In a step 710, a next image is captured. For example, another image of the sample 104 may be received.

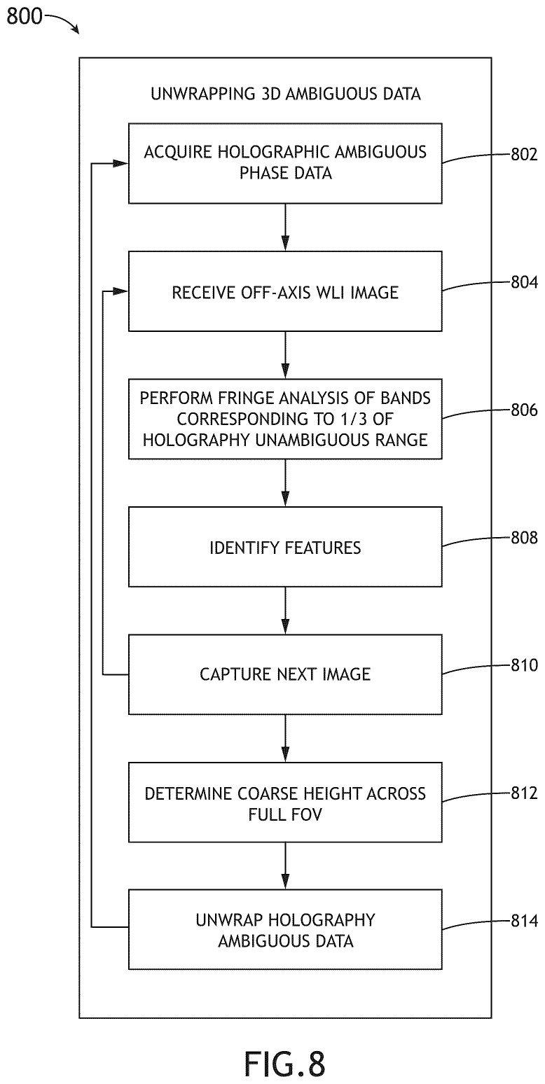

FIG. 8 illustrates a flow diagram illustrating steps performed in a method 800, in accordance with one or more embodiments of the present disclosure.

In a step 802, an image is received. For example, scanning microscopy ambiguous (i.e., unwrapped) phase data may be received, such as from a different imaging method.

In a step 804, an off-axis white light interferometry (WLI) image is received such as via the optical sub-system 102.

In a step 806, fringe analysis is performed on the image received in step 804. For example, fringe analysis may be performed on fringe bands of an interference pattern 302 that correspond to one-third (and/or more than one-third) of a holography unambiguous range. For example, the holography unambiguous range may be based on (and/or equal to) a wavelength used in acquiring the image of step 802. In this regard, the fringe bands that are most likely to cause errors in a phase unwrapping process may be analyzed and used to improve the unwrapping process.

In a step 808, features are identified.

In a step 810, a next image is captured. Note that steps 804 through 810 may be performed repeatedly and continuously, such as during a lateral scan configured to map a surface height topology of the sample 104. In this regard, the entire sample 104 or a portion thereof may be inspected.

In a step 812, a height (e.g., coarse height) is determined across a full field of view (FOV). For example, a height may be determined across a full FOV of the sample 104.

In a step 814, holography ambiguous data is unwrapped. For example, scanning microscopy phase maps may be unwrapped based on the surface height topology.

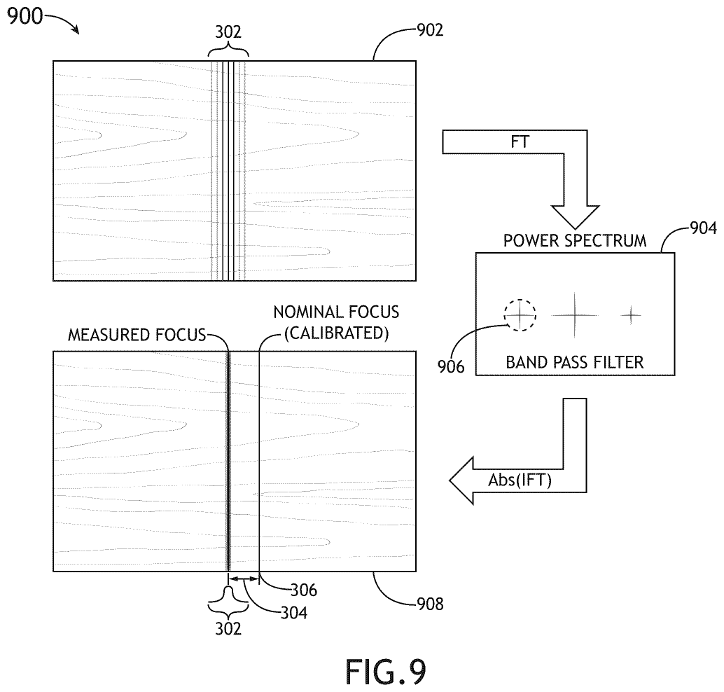

FIG. 9 illustrates a flow diagram illustrating steps performed in a method 900 utilizing a band pass filter 904, in accordance with one or more embodiments of the present disclosure.

In embodiments, an image (e.g., image 300) may be adjusted (e.g., filtered, etc.) to improve analysis of interference patterns 302.

In a first step, an image 902 is received of the sample 104. For example, the image may be configured to be captured by detector 124.

In a second step, a band pass filter is utilized to generate an envelope of the interference pattern 302 as shown in image 908. The location of the interference pattern 302 may be considered to be the center/peak of the interference pattern envelope. Alternatively, and/or in addition, the location of the interference pattern 302 may be determined using a fit function (e.g., any fit function such as a Gaussian fit function) fit to the envelope in the vicinity of the peak. The band pass filter 904 may conceptually filter a portion 906 of a power spectrum as shown.

For example, a physical and/or digital band pass filter may be utilized to filter the image 902 received in the first step. The band pass filter may be configured to filter out noise, other undesired frequencies, and/or features from the image. A physical band pass filter can be a physical device, such as a filter wheel, that is placed in front of the detector 124 of the optical sub-system 102 and a digital band pass filter may be based on image processing algorithms configured to filter an image known in the art.

Using a band pass filter as a filter can be a useful tool for analyzing interference patterns, allowing for more accurate analysis of the interference pattern. By filtering out noise, the interference pattern can be more easily identified and analyzed. Additionally, a band pass filter can be used to identify one or more layers in an image, such as one or more semi-transparent layers. This can be useful for analyzing the structure of a sample, such as for identifying defects or other features. The filtered interference pattern can be generated using an inverse Fourier transform (IFT), which is a mathematical operation that converts a frequency domain representation of a signal into a space domain representation. The filtered interference pattern can then be used to generate image 908, which can be used for further analysis.

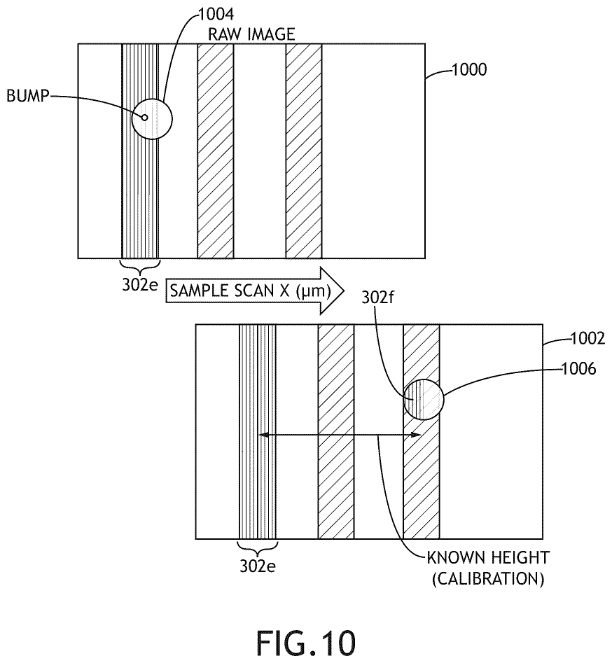

FIG. 10 illustrates simplified views of images 1000, 1002 of a bump feature 1004 during a lateral scan as may be utilized in a phase map unwrapping process (e.g., see FIGS. 8 and/or 9), in accordance with one or more embodiments of the present disclosure. In embodiments, features that are in a region of interest (ROI) are tracked during a lateral scan.

The first image 1000 illustrates the bump feature 1004 during a lateral scan in the x-direction. The first image 1000 may be generated by the optical sub-system 102 using an off-axis configuration. The image 1000 may include an interference pattern 302e that is generated by the interference of a reference beam 150 and a measurement beam 140.

The second image 1002 illustrates the same bump feature 1006 in a different location during the lateral scan. In embodiments, a feature detection may occur when a feature enters a ROI. As shown, the bump feature causes interference patterns 302f to be generated. When interference patterns 302f are generated in a particular area (e.g., ROI) of the image, such as shown by image 1002, then a registration of the feature may be determined. The registration may be stored on memory 112 and used to map features of a sample 104. For example, a region of interest may be defined as being a distance (e.g., pixel distance) that corresponds to a change in height equal to (and/or greater than) one-third of an ambiguous unwrapping range (e.g., one-third of wavelength).

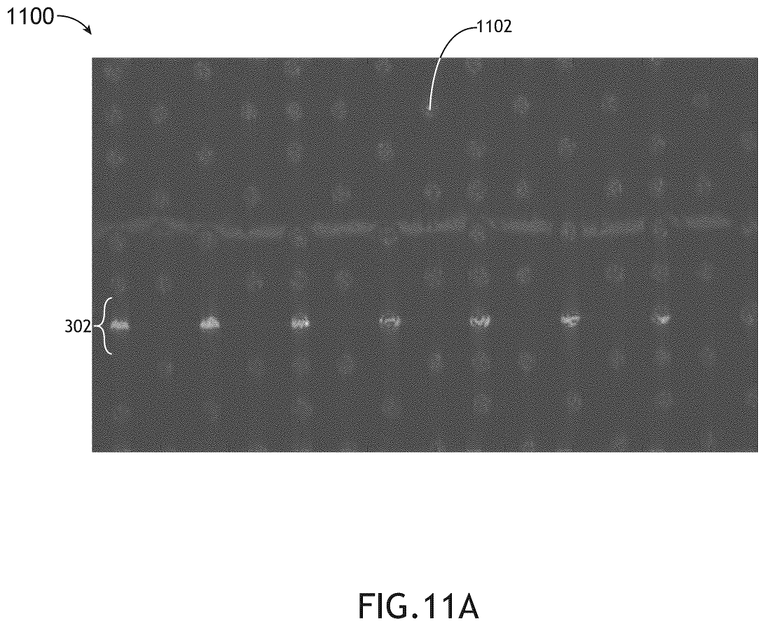

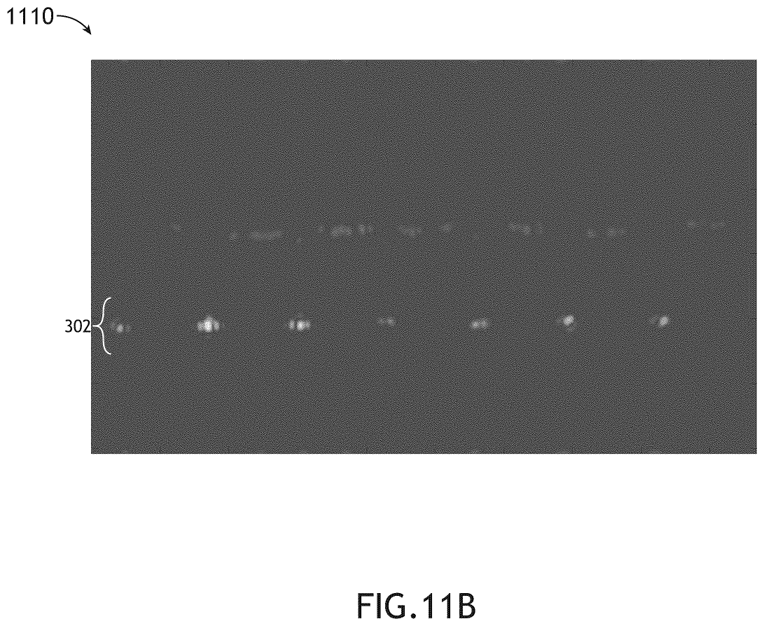

FIGS. 11A and 11B may illustrate analyzing noisy spatial frequency images, such as may be caused by periodic features 1102 (e.g., bumps and the like).

In embodiments, an image is filtered to narrow a size of a spatial filter window (e.g., as may be defined by an area of a spatial spectrum (two-dimensional FFT)). For example, a spatial filtered image may be generated from an image (e.g., 300) of the sample 104. An example of a location for a physical spatial filter component is shown by collection component 132 in FIG. 1B, which may include a spatial filter.

FIG. 11A illustrates a demodulated image 1100 of periodic features 1102 and interference patterns 302, in accordance with one or more embodiments of the present disclosure. For example, image 1100 may be generated by demodulating an originally captured image by applying a band pass filter.

FIG. 11B illustrates a filtered image 1110 after applying a narrower bandpass filter (compared to FIG. 11A) to demodulate the interference patterns 302, in accordance with one or more embodiments of the present disclosure. In this regard, the interference patterns 302 in FIG. 11B, which are demodulated fringe patterns, may be more easily distinguished from the periodic features.

In embodiments, by laterally scanning the sample 104 and sequential image acquisition (with an appropriate frame rate) it is possible in principle to reconstruct the height profile provided the contrast of the interference signal is high enough, and can be well-separated from the spatial frequencies of the periodic features on the sample.

In embodiments, the controller 108 may be configured to generate vertical scan data (e.g., effective vertical scan data). For example, the vertical scan data may be three-dimensional data.

In embodiments, an analysis of the image for purposes of determining the interference pattern 302 may be limited to one or more areas. In this regard, an analysis may be less computationally expensive, thereby further speeding up operations such as focusing and lateral scanning of a sample 104. For example, the determining of the location of the interference pattern 302 may be limited to a select portion of the image. The select portion may be any portion, such as, but not necessarily limited to, a cropped portion of an image using a pre-selected cropping, or a portion may include a location of an expected interference pattern based on a likely location of the interference pattern 302. For example, the pre-selected cropping may be 10% or less (or the like) such that the outermost 10% of the image on each side is not analyzed.

Referring again to FIGS. 1A and 1B, embodiments of various components are described in additional detail.

In embodiments, the illumination pathway 118 includes one or more illumination lenses 126 to direct the illumination beam 116 from the illumination source 114 to the sample 104. Additionally, the illumination lenses 126 may be arranged to relay one or more field planes or pupil planes to locations within the illumination pathway 118. The illumination pathway 118 may further include one or more illumination conditioning components 128 suitable for modifying and/or conditioning the illumination beam 116. The illumination conditioning components 128 may be, but are not required to be, located at field planes and/or pupil planes in the illumination pathway 118. For example, the one or more illumination conditioning components 128 may include, but are not limited to, an illumination aperture stop, an illumination field stop, one or more polarizers, one or more compensators, one or more filters, one or more beam splitters, one or more diffusers, one or more homogenizers, one or more apodizers, one or more beam shapers, one or more mirrors, one or more lenses, and/or one or more masks.

In embodiments, the collection pathway 120 includes one or more collection lenses 130 to direct the detectable light 122 from the sample 104 to the detector 124. In another embodiment, the collection pathway 120 includes one or more collection conditioning components 132 suitable for modifying and/or conditioning the detectable light 122. For example, the one or more collection conditioning components 132 may include, but are not limited to, one or more polarizers, one or more filters, one or more beam splitters, one or more diffusers, one or more apodizers, or one or more beam shapers.

It is noted herein that the one or more components of the characterization system 100 may be communicatively coupled to the various other components of characterization system 100 in any manner known in the art. For example, the one or more processors 110 may be communicatively coupled to each other and other components via a wireline (e.g., copper wire, fiber optic cable, and the like) or wireless connection (e.g., RF coupling, IR coupling, WiMax, Bluetooth, 3G, 4G, 4G LTE, 5G, and the like). By way of another example, the controller 108 may be communicatively coupled to one or more components of characterization system 100 via any wireline or wireless connection known in the art.

In one embodiment, the one or more processors 110 may include any one or more processing elements known in the art. In this sense, the one or more processors 110 may include any microprocessor-type device configured to execute software algorithms and/or instructions. In one embodiment, the one or more processors 110 may consist of a desktop computer, mainframe computer system, workstation, image computer, parallel processor, or other computer system (e.g., networked computer) configured to execute a program configured to operate the characterization system 100, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors 110. In general, the term “processor” may be broadly defined to encompass any device having one or more processing elements, which execute program instructions from memory 112. Moreover, different subsystems of the characterization system 100 (e.g., optical sub-system 102, interferometer, controller 108, user interface, and the like) may include processor or logic elements suitable for carrying out at least a portion of the steps described throughout the present disclosure. Therefore, the above description should not be interpreted as a limitation on the present disclosure but merely an illustration.

The memory 112 may include any storage medium known in the art suitable for storing program instructions executable by the associated one or more processors 110 and the data received from the characterization system 100. For example, the memory 112 may include a non-transitory memory medium. For instance, the memory 112 may include, but is not limited to, ROM, RAM, a magnetic or optical memory (e.g., disk), a magnetic tape, a solid-state drive and the like. It is further noted that the memory 112 may be housed in a common controller housing with the one or more processors 110. In an alternative embodiment, the memory 112 may be located remotely with respect to the physical location of the processors 110, controller 108, and the like. In another embodiment, the memory 112 maintains program instructions for causing the one or more processors 110 to carry out the various steps described through the present disclosure.

In one embodiment, the user interface is communicatively coupled to the controller 108. The user interface may include, but is not limited to, one or more desktops, tablets, smartphones, smart watches, or the like. In another embodiment, the user interface includes a display used to display data of the characterization system 100 to a user. The display of the user interface may include any display known in the art. For example, the display may include, but is not limited to, a liquid crystal display (LCD), an organic light-emitting diode (OLED) based display, or a CRT display. Those skilled in the art should recognize that any display device capable of integration with a user interface is suitable for implementation in the present disclosure. In another embodiment, a user may input selections and/or instructions responsive to data displayed to the user via a user input device of the user interface.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be RAM, and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “vertical”, “lateral”, “top,” “bottom,” “over,” “under,” “upper,” “upward,” “lower,” “down,” “downward”, and the like are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A characterization system for characterizing a sample utilizing white light interferometry comprising:
an optical sub-system comprising:
a detector configured for multi-pixel imaging;
an illumination source configured to generate an illumination beam;
a beamsplitter configured to split the illumination beam into a measurement beam and a reference beam;
a reference element configured to tilt an optical axis of the reference beam relative to an optical axis of the measurement beam; and
a sample positioning stage configured to adjust a sample position of the sample along a Z-direction associated with a focal distance of the optical sub-system; and
a controller communicatively coupled to the detector and the sample positioning stage, wherein the controller includes one or more processors configured to execute program instructions causing the one or more processors to:
receive an image of the sample;
utilize a filter to demodulate an interference pattern of the image;
determine a location of the interference pattern on the image; and
direct a focal adjustment based on the location of the interference pattern, wherein the focal adjustment includes adjusting at least one of the sample positioning stage or an optical element of the optical sub-system.

2. The characterization system of claim 1, wherein controller is further configured to cause the one or more processors to:
perform a selective blocking of the reference beam for receiving a secondary image without the interference pattern.

3. The characterization system of claim 2, wherein the selective blocking is configured to be performed repeatedly during a lateral scan for receiving a plurality of secondary images.

4. The characterization system of claim 1, wherein determining the location of the interference pattern is limited to a select portion of the image.

5. The characterization system of claim 1, wherein directing the focal adjustment based on the location of the interference pattern comprises:
directing the focal adjustment based on the location of the interference pattern during lateral scanning of the sample to maintain focus.

6. The characterization system of claim 1, wherein controller is further configured to cause the one or more processors to:
generate vertical scan data along the depth direction of the sample during a lateral scanning of the sample.

7. The characterization system of claim 1, wherein directing the focal adjustment based on the location of the interference pattern comprises:
directing the focal adjustment based on the location of the interference pattern to generate a surface height topology of the sample.

8. The characterization system of claim 7, wherein the controller is further configured to execute the program instructions causing the one or more processors to:
unwrap a phase map based on the surface height topology.

9. The characterization system of claim 8, wherein unwrapping the phase map based on the surface height topology comprises unwrapping scanning microscopy phase maps based on the surface height topology.

10. The characterization system of claim 1, wherein the controller is further configured to execute the program instructions causing the one or more processors to:
receive a calibrated focus location; and
determine a difference between the calibrated focus location and the location of the interference pattern on the image.

11. The characterization system of claim 10, wherein directing the focal adjustment based on the location of the interference pattern comprises directing the focal adjustment based on the difference.

12. The characterization system of claim 1, wherein receiving the image of the sample comprises:
receiving the image of the sample during a lateral scanning of the sample.

13. The characterization system of claim 12, wherein directing the focal adjustment comprises directing the focal adjustment continuously for each received image such that the sample is continuously maintained in focus during the lateral scanning of the sample.

14. The characterization system of claim 1, wherein the optical sub-system comprises an external interferometer configuration.

15. The characterization system of claim 1, wherein the optical sub-system comprises an in-objective interferometer configuration such that the beamsplitter is located after an objective lens along a direction of propagation of the illumination beam.

16. The characterization system of claim 1, wherein the filter comprises at least one of a spectral filter or a spatial filter to create a filtered interference pattern.

17. The characterization system of claim 16, wherein the at least one of the spectral filter or the spatial filter includes a band pass filter.

18. The characterization system of claim 1, wherein the controller is further configured to execute the program instructions causing the one or more processors to: identify one or more layers based on the interference pattern, wherein the one or more layers are semi-transparent.

19. The characterization system of claim 1, wherein the one or more layers include one or more semi-transparent layers.

20. A method comprising:
providing an optical sub-system configured for characterizing a sample utilizing white light interferometry comprising: a reference element configured to tilt an optical axis of a reference beam relative to an optical axis of a measurement beam and a sample positioning stage configured to adjust a sample position of a sample along a Z-direction of the sample;
receiving an image of the sample;
utilizing a filter to demodulate an interference pattern of the image;
determining a location of the interference pattern on the image; and
directing a focal adjustment based on the location of the interference pattern, wherein the focal adjustment includes adjusting at least one of the sample positioning stage or an optical element of the optical sub-system.

21. The method of claim 20 further comprising performing a selective blocking of the reference beam for receiving a secondary image without the interference pattern.

22. The method of claim 21, wherein the selective blocking is configured to be performed repeatedly during a lateral scan for receiving a plurality of secondary images.

23. The method of claim 20, wherein determining the location of the interference pattern is limited to a select portion of the image.

24. The method of claim 20, wherein directing the focal adjustment based on the location of the interference pattern comprises:
directing the focal adjustment based on the location of the interference pattern during lateral scanning of the sample to maintain focus.

25. The method of claim 20 further comprising generating vertical scan data along a depth direction of the sample during a lateral scanning of the sample.

26. The method of claim 20, wherein directing the focal adjustment based on the location of the interference pattern comprises:
directing the focal adjustment based on the location of the interference pattern to generate a surface height topology of the sample.

27. The method of claim 26, further comprising:
unwrapping a phase map based on the surface height topology.

28. The method of claim 27, wherein unwrapping the phase map based on the surface height topology comprises unwrapping scanning microscopy phase maps based on the surface height topology.

29. The method of claim 20 further comprising:
receiving a calibrated focus location; and
determining a difference between the calibrated focus location and the location of the interference pattern on the image.

30. The method of claim 29, wherein directing the focal adjustment based on the location of the interference pattern comprises directing the focal adjustment based on the difference.

31. The method of claim 20, wherein the receiving the image of the sample comprises:
receiving the image of the sample during a lateral scanning of the sample.

32. The method of claim 31, wherein directing the focal adjustment comprises directing the focal adjustment continuously for each received image such that the sample is continuously kept in focus during the lateral scanning of the sample.

33. The method of claim 20, wherein the optical sub-system comprises an external interferometer configuration.

34. The method of claim 20, wherein the method is performed via an optical sub-system comprising an in-objective interferometer configuration such that a beamsplitter is located after an objective lens.

35. The method of claim 20, wherein the filter comprises at least one of a spectral filter or a spatial filter to create a filtered interference pattern.

36. The method of claim 20, wherein the at least one of a spectral filter or a spatial filter comprises a band pass filter.

37. The method of claim 20 further comprising identifying one or more layers based on the interference pattern.

38. The method of claim 37, wherein the one or more layers include one or more semi-transparent layers.
